(19) United States
(12) Patent Application Publication
(10) Pub. No.: US 2011/0259713 A1
(43) Pub. Date: Oct. 27, 2011

(54) SPIRAL CONVEYOR APPARATUS WITH AUTOMATIC FLOW CONTROL AND MERGE/DIVERT ATTACHMENT

(75) Inventors: Duane Lee Glass, Smithsburg, MD (US); Bryan Todd Humbertson, Frostburg, MD (US)

(73) Assignee: CARTER CONTROL SYSTEMS, INC., Frederick, MD (US)

(21) Appl. No.: 13/091,270

(22) Filed: Apr. 21, 2011

Related U.S. Application Data
(60) Provisional application No. 61/327,277, filed on Apr. 23, 2010.

(51) Int. Cl. B65G 47/10; B65G 47/46

(52) U.S. Cl. 198/370.01

(57) ABSTRACT

A spur section for connecting a primary conveyor to a secondary conveyor is provided. The spur section includes a frame configured for attachment to a selected segment of a primary conveyor, a driving element and a driven element associated with the frame, and a driver that powers the driving element. A sensor is arranged on the selected segment of the primary conveyor that detects a conveyed article and selectively generates a divert signal or a merge signal. A controller receives the divert signal or merge signal from the sensor and controls the driving element in accordance with the divert signal or merge signal.

### CROSS REFERENCE TO RELATED APPLICATIONS

This application claims the benefit of U.S. Provisional Patent Application Ser. No. 61,327,277, filed on Apr. 23, 2010, which is incorporated by reference as if fully set forth herein.

### FIELD OF INVENTION

This application is generally related to conveyor apparatuses, and more particularly related to a spur section attached to a spiral conveyor to automatically divert articles from the spiral conveyor or merge articles onto the spiral conveyor.

### BACKGROUND

Conveyors systems that use gravity or driving elements to move articles from one location to another are widely used in many different industries and applications, and are often formed as a spiral conveyor. An article enters the spiral conveyor from an entry portion, and moves towards an exit portion along a conveying path of the spiral conveyor, which often includes a plurality of rollers, wheels, or balls that aid movement of the article. In addition to using gravity to move the article, the spiral conveyor may include driving elements, such as powered rollers or powered belts, that move the article along the conveying path. As articles travel along a conveyor system, it is often necessary to stop or slow the flow of articles to prevent the articles from being damaged or jammed in a segment of the conveyer. U.S. Pat. No. 5,901,827, which is incorporated by reference as if fully set forth herein, describes an apparatus that controls the movement of articles through a conveyor by using selectively actuated powered rollers to assist the transport of articles along the conveyor. Sensing means are arranged on the conveyor to determine whether the articles in a segment of the conveyor should be transported or accumulated, and a control means uses information from the sensing means to actuate the powered rollers accordingly.

While stopping or slowing the flow of articles in a conveyor has proven useful, there is still a need to occasionally divert articles from the main conveying path and then reintroduce those articles, such as for sortation purposes or to prevent jamming. In addition, it may be necessary to permanently divert articles from the main conveying path onto a secondary conveyor, for example to remove damaged articles from the conveyor. A need thus exists for an apparatus that can be installed on an existing conveyor to divert or merge articles between the existing conveyor and a secondary conveyor, using sensors and controls to determine when a conveyed article should be diverted or merged and to coordinate movement of the conveyed article with the flow of articles on the existing conveyor.

### SUMMARY

A spur section includes a frame configured for attachment to a selected segment of a primary conveyor, driving and driven element associated with the frame, and a driver that powers the driving element. A sensor is arranged on the selected segment of the primary conveyor that detects a conveyed article and selectively generates a divert signal or a merge signal. A controller receives the divert signal or merge signal from the sensor and controls the driving element in accordance therewith.

A method for diverting and merging a conveyed article includes the step of providing a primary conveyor, and connecting a spur section to the primary conveyor, the spur section having a driving element. The method further includes the steps of connecting a secondary conveyor to the spur section, and arranging a sensor on the primary conveyor at a predetermined distance from the spur section, the sensor being configured to detect a condition of a conveyed article and selectively generate a divert signal or a merge signal. A controller receives the divert signal or the merge signal and controls the driving element of the spur section in accordance with that signal to divert a conveyed article away from the primary conveyor or merge a conveyed article onto the primary conveyor.

For sake of brevity, this summary does not list all aspects of the present device, which are described in further detail below and in the appended claims.

### BRIEF DESCRIPTION OF THE DRAWINGS

The foregoing summary, as well as the following detailed description of the preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements shown.

FIG. 1 is an illustrative side view of a spiral conveyor with an attached spur section for connection to a secondary conveyor.

FIG. 2 is a top view of a spiral conveyor illustrating potential locations for attachment of a spur section.

FIG. 3 is a perspective view of a spur section.

FIG. 4 is a top plan view of the spur section shown in FIG. 3.

FIG. 5 is a top plan view of the spur section shown in FIG. 3 with optional belts arranged over the rollers.

FIG. 6 is a top plan view of a spur section according to FIGS. 3 and 4 connected to a spiral conveyor, showing the guide mechanism in a retracted position.

FIG. 7 is a top plan view of a spur section according to FIGS. 3 and 4 connected to a spiral conveyor, showing the guide mechanism in an extended position.

FIG. 8 is a top plan view of an alternate embodiment of the spur section connected to a spiral conveyor, showing the guide mechanism in a retracted position.

FIG. 9 is a top plan view of the spur section shown in FIG. 8 connected to a spiral conveyor, showing the guide mechanism in an extended position.

FIG. 10 is a flow diagram showing a method for diverting and merging a conveyed article between a primary conveyor and a secondary conveyor.

FIG. 11 is a top plan view of a plurality of the spur sections shown in FIG. 8 connected to a spiral conveyor.

FIG. 12 is a perspective view of a plurality of spur sections connected to a spiral conveyor.

### DETAILED DESCRIPTION OF THE PREFERRED EMBODIMENTS

Certain terminology is used in the following description for convenience only and is not limiting. The words “top,” “bottom,” “upper,” and “lower” designate directions in the drawings to which reference is made. The terminology includes the words specifically noted above, derivatives thereof, and words of similar import.

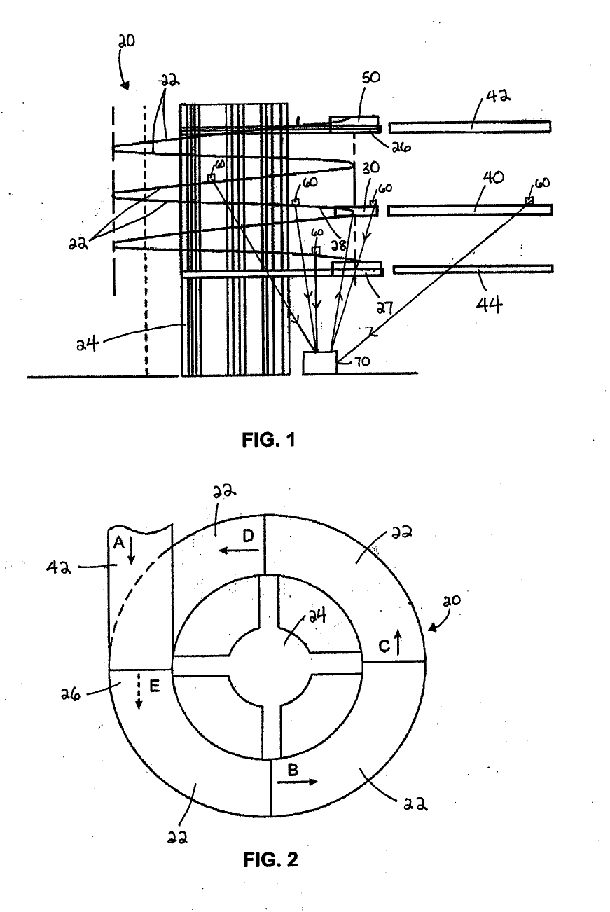

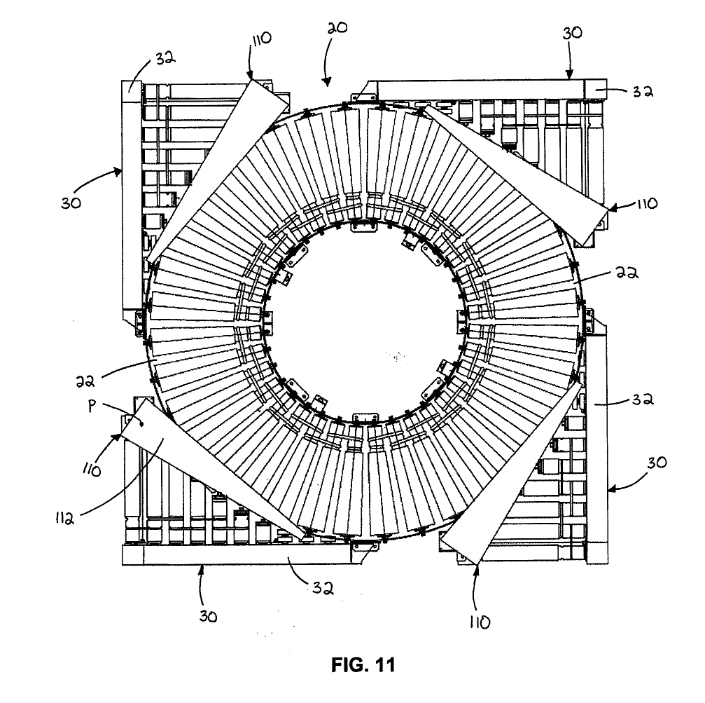

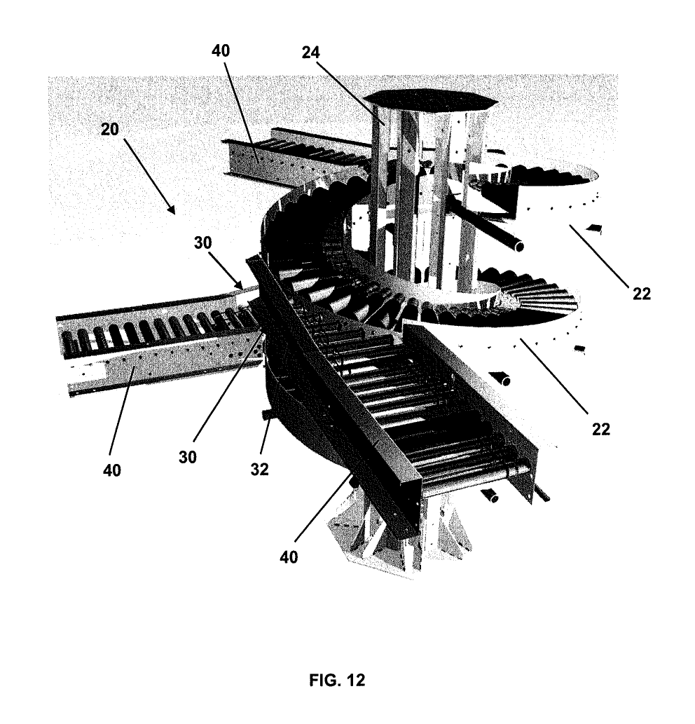

FIG. 1 shows a conventional spiral conveyor 20 on which a spur section 30 according to the present application can be attached to merge or divert articles between the spiral conveyor 20 and a secondary conveyor 40. As shown by FIGS. 1, 2, 6-9, and 12, the spiral conveyor 20 includes a plurality of conveyor segments 22 supported by a conveyor frame 24 and arranged as a spiral forming a conveying path for a conveyed article 50. The conveyor segments 22 can be formed as curved segments, such as 90° arcs, that are shaped to have a uniform, predetermined cant, which allows the conveyor segments 22 to be joined together to form a spiral spanning a desired height. The conveyor segments 22 can include an entry segment 26 arranged at a first level and an exit segment 27 arranged at a second level, or vice versa, and can further include motion transmission elements such as roller devices that provide a conveying surface for the conveyed article 50 to travel between the entry segment 26 and the exit segment 27. The spiral conveyor 20 can be connected to a larger conveyor system having a feed conveyor 42 to deliver articles to the spiral conveyor 20 and a takeaway conveyor 44 to divert articles away from the spiral conveyor 20. The spur section 30 is preferably connected to one of the conveyor segments 22 at an intermediary level between the first and second levels to connect that conveyor segment to a secondary conveyor 40 for diverting or merging a conveyed article 50 between the spiral conveyor 20 and the secondary conveyor 40. The spur section 30 can be connected to a selected segment 28 of the spiral conveyor 20 at any convenient location. For example, if the feed conveyor 42 having a direction A is connected to the entry segment 26 of the spiral conveyor 20 as shown in FIG. 2, the spur section 30 can be connected, after an appropriate number of intervening segments for a desired height change, to a selected conveyor segment so that that the direction of the spur section 30 is substantially parallel C, E, or perpendicular B, D, to the feed conveyor 42 direction A. Alternatively, the spur section 30 can be arranged at a different angle, such as an oblique angle, with respect to the feed conveyor 42 direction A. Additionally, as shown in FIGS. 11 and 12, a plurality of spur sections 30 can be connected to the spiral conveyor 20 at various positions between the entry segment 26 and the exit segment 27 so that conveyed articles can be merged or diverted between the spiral conveyor 20 and multiple secondary conveyors arranged at different levels, such as for vertical sortation. While FIGS. 1, 6-9, 11, and 12 show the spur section 30 connected to a spiral conveyor 20, one of ordinary skill in the art would appreciate that the present spur section 30 can be used with other conveyor configurations to merge or divert conveyed articles between different conveyors.

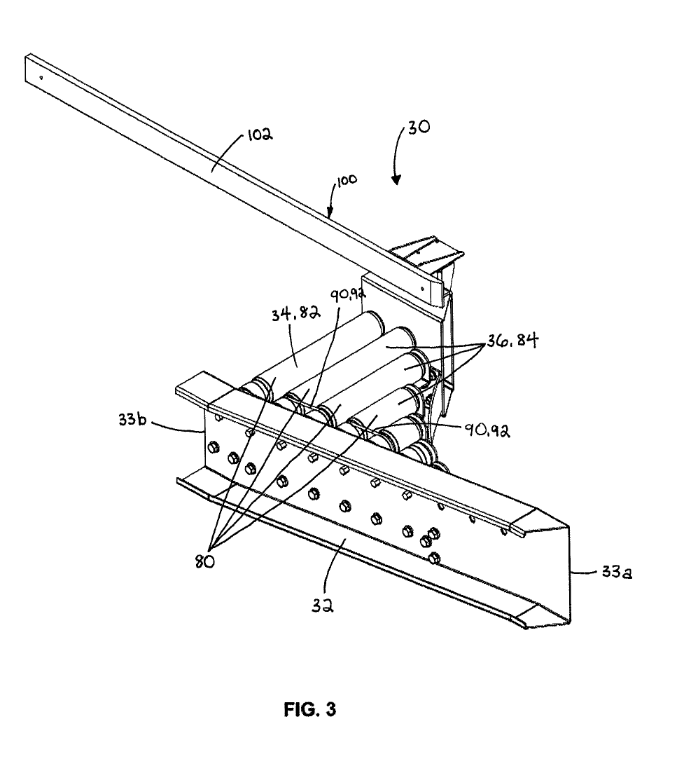

FIGS. 3-5 show one embodiment of the spur section 30 according to the present application. The spur section 30 includes a frame 32 configured for attachment to a selected segment 28 of a primary conveyor, such as the spiral conveyor 20 described above. One of ordinary skill in the art would understand that the spur section 30 is not in itself a conveyor from one point to another, but rather functions in cooperation with a conveyor, such as for connecting the spiral conveyor 20 to a secondary conveyor 40. Where the spur section 30 is connected to a spiral conveyor 20, the frame 32 can have a substantially triangular shape to match the curvature of the conveyor segments 22. The frame 32 can include a first end 33a configured for attachment to the spiral conveyor 20, and an opposing second end 33b configured for attachment to the secondary conveyor 40. The spur section 30 further includes a driving element 34 and at least one driven element 36 associated with the frame 32. A driver 38 such as a motor powers the driving element 34, and can also be associated with the frame 32.

The spur section 30 can be formed as a divert spur designed to divert a conveyed article 50 away from the spiral conveyor 20 to the secondary conveyor 40, with the driving element 34 and driven element 36 moving in a direction away from the spiral conveyor 20. The spur section 30 can also be formed as a merge spur designed to merge a conveyed article 50 from the secondary conveyor 40 onto the spiral conveyor 20, with the driving element 34 and driven element 36 moving in a direction towards the spiral conveyor. Alternatively, the spur section 30 can be formed as a reciprocating spur section, so that the driving element 34 and driven element 36 can move in opposing directions to divert a conveyed article 50 away from the spiral conveyor 20, or merge a conveyed article 50 onto the spiral conveyor 20. As shown in the simplified illustration of FIG. 1, a sensor 60 is arranged on the selected segment 28 of the spiral conveyor 20 to detect a conveyed article 50 and generate a divert signal or a merge signal. The sensor 60 is preferably positioned at a sufficient distance from the spur section 30, so that it can detect the conveyed article 50 and selectively generate the divert signal or merge signal before the conveyed article 50 reaches the spur section 30. A controller 70 in communication with the sensor 60 and the driver 38 receives the divert signal or the merge signal from the sensor 60 and controls the driving element 34 in accordance with the received signal. The controller 70 can be associated with the frame 32 of the spur section 30, or arranged at a different location from the spur section 30. The controller 70 may communicate with the sensor 60 and driver 38 through a wired connection or wirelessly.

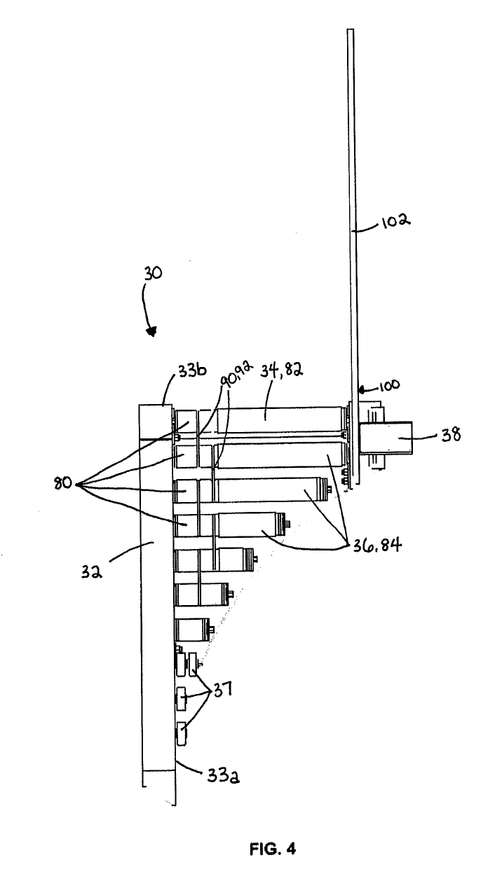

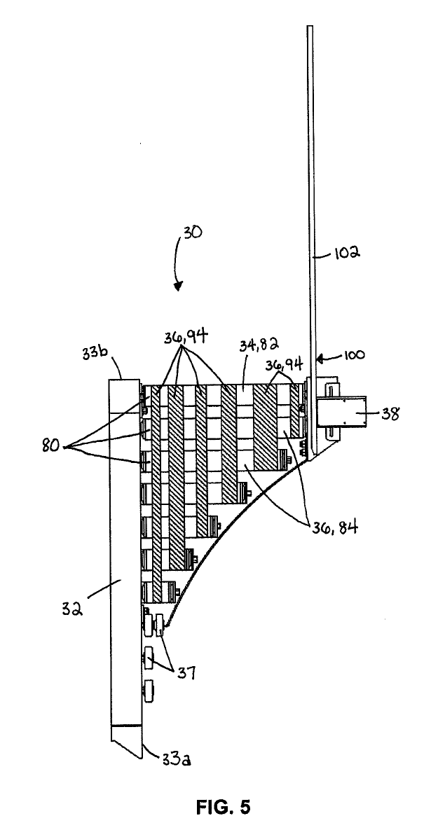

As shown in FIGS. 3-5, the driving element 34 and driven element 36 may be formed as a plurality of cylindrical rollers 80 supported by the frame 32. One of ordinary skill in the art would appreciate that the driving and driven elements 34, 36 can include other suitable devices, such as, for example and without limitation, belts, skate wheels, or roller balls. The spur section 30 can also include non-driven elements to aid in movement of a conveyed package 50, such as the wheels 37 shown in FIGS. 3 and 5. In the embodiment shown in FIGS. 3 and 4, the driving element 34 includes a powered roller 82, and the driven element 36 includes a plurality of non-powered rollers 84. Powered, reversible rollers suitable for the present spur section 30 are available from several roller manufactures, for example, the Interroll Model 8.220P44D15 is one such suitable roller. The powered roller 82 may include an outer coating of PVC to provide a suitable friction surface. The powered roller 82 rotates at a set speed and can add thrust to speed up slower moving, light weight articles, or drag on faster moving, heavier articles to slow them, as required during the diverting or merging operation. The non-powered rollers 84 are driven by the powered roller 82 through a power transmission element 90, such as a plurality of bands 92 that connect the powered roller 82 to an adjacent non-powered roller 84, and subsequent adjacent non-powered rollers 84 to each other. In this manner, the bands 92 transmit the rotation of the powered roller 82 to the non-powered rollers 84 to aid movement of a conveyed article 50 along the spur section. The powered roller 82 can be located at any convenient location on the spur section 30. For reasons of manufacturing convenience, the powered roller 82 is generally mounted at the end of the spur section 30 that connects to the secondary conveyor 40.

In addition to the non-powered rollers 84, the driven element 36 can further include a belt 94 arranged around the driving element 34. As shown in FIG. 5, due to the shape of the spur section 30, a plurality of thin belts 94 can be arranged around the powered roller 82 and the non-powered rollers 84. The belts 94 may have different widths and lengths. Rotation of the powered roller 82 drives the belts 94 to move a conveyed article 50 along the spur section 30. The belts 94 are preferably arranged substantially perpendicular to the powered roller 82 and non-powered rollers 84. The type of driving and driven elements 34, 36 used depends on the application of the conveyor system, as cylindrical rollers and wheels are more suited for larger packages or stiff packages, whereas belts and roller balls are more suitable for smaller packages or flexible packages having unstable bottoms, such as soft packs or plastic packages. While only one powered roller 82 is shown in FIGS. 3-5, a plurality of powered rollers 82 may be provided on the spur section 30 to provide additional driving force, depending on the specific application and the length of the spur section 30.

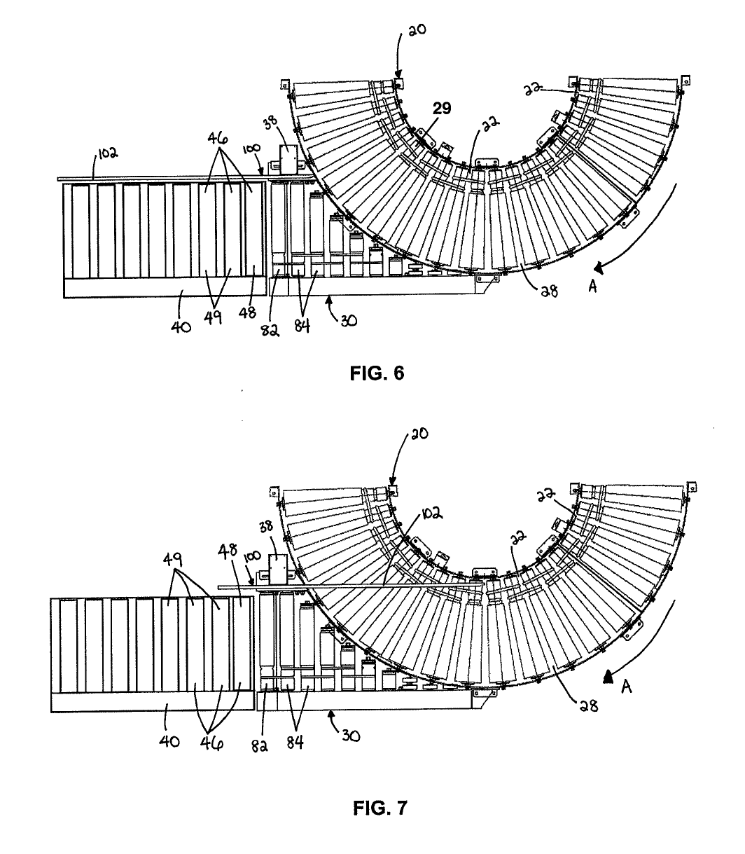

As shown in FIGS. 6-9, when the spur section 30 shown in FIGS. 3-5 is connected between a selected segment 28 of the spiral conveyor 20 and a secondary conveyor 40, the powered and non-powered rollers 82, 84 of the spur section 30 can be arranged substantially parallel to the rollers 46 of the secondary conveyor 40. This arrangement allows a conveyed article 50 to easily move between the spur section 30 and the secondary conveyor 40 as it is being diverted from or merged onto the spiral conveyor 20. The rollers 46 of the secondary conveyor 40 can also include at least one powered roller 48 that drives a plurality of non-powered rollers 49 in the same manner described above with respect to the spur section 30, to aid in movement of the conveyed article 50 along the secondary conveyor 40 and between the secondary conveyor 40 and the spur section 30. The powered roller 48 of the secondary conveyor 40 can be powered by its own driver or the same driver 38 as that of the spur section 30. Where the powered roller 48 of the secondary conveyor 40 is powered by a different driver from the spur section 30, the driver for the secondary conveyor 40 can be in communication with the controller 70 of the spur section 30 so that operation of the powered rollers 82, 48 of the spur section 30 and the secondary conveyor 40 can be synchronized.

As discussed above, the sensor 60 arranged on the spiral conveyor 20 is preferably positioned at a sufficient distance from the spur section 30 to detect the presence of a conveyed article 50 before it reaches the spur section 30 and to send a signal to the controller 70 for activating the driver 38, so that the driving element 34 of the spur section 30 is rotating in the proper direction as the conveyed article 50 reaches the spur section 30. The sensor 60 can be positioned at approximately the midpoint of the selected segment 28. Alternatively, the sensor 60 can be positioned at any location upstream or downstream of the spur section 30, and the controller 70 can be programmed to take into account the distance, if necessary, between the sensor 60 and the spur section 30. As shown in the illustration of FIG. 1, a plurality of sensors 60 can be arranged upstream of the spur section 30 to detect the presence of conveyed articles 50 and relay corresponding signals to the controller 70. In addition, one or more additional sensors 60 can be arranged downstream of the spur section 30 to detect the presence of a conveyed article 50 and generate an additional signal that is received by the controller 70, which controls the driver 38 and driving element 34 accordingly. For example, the additional sensor 60 can detect a jamming condition downstream of the spur section 30, and send a divert signal to the controller 70 so that conveyed articles 50 can be diverted from the spiral conveyor 20 to a secondary conveyor 40. Once the additional sensor 60 detects that the jamming condition has been resolved, it can send a merge signal to the controller 70 so that the divert articles can be reintroduced from the secondary conveyor 40 onto the spiral conveyor 20. Further sensors 60 can be arranged on the spur section 30 and the secondary conveyor 40 to detect the presence of a conveyed article 50 on those sections and generate corresponding signals to the controller 70, which further controls the movement of articles during the merging or diverting operation. For example, a sensor 60 arranged on the secondary conveyor 40 can indicate when a secondary conveyor 40 is at capacity, so that further articles can be diverted onto other secondary conveyors. If a sensor 60 is arranged on the spur section 30, it is preferably positioned near the end of the spur section 30 that connects to the selected segment 28 of the spiral conveyor 20. The sensors 60 can be any suitable sensing device, such as, for example and without limitation, a photoelectric device having a light source and a photocell, or a mechanical switch having a leaf interposed in the conveying path. The controller 70 can be a programmable microprocessor that is configured to receive signals from each one of the sensors 60 and, in response to those signals, to control the driver 38 and driving element 34 to divert or merge a conveyed article 50 between the spiral conveyor 20 and a secondary conveyor 40.

The present spur section 30 is especially advantageous because it can be easily integrated with an existing conveyor system for diverting or merging conveyed articles, such as the spiral conveyor disclosed in U.S. Pat. No. 5,901,827 or spiral conveyors made by companies including Ryson International, Inc. and AmbaFlex, Inc. The size of the frame 32 and the number and size of the driving and driven elements 34, 36 can be modified to match the existing conveyor system. For example, where a powered roller 82 is used as the driving element 34, the powered roller 82 can be of the same type and size as the powered rollers being used on the conveyor system. The controller 70 of the spur section 70 can be configured to communicate with the existing conveyor system's controller and sensors, or to control the existing conveyor system's driver and driving elements to coordinate the diverting and merging operations. The adaptability of the present spur section 30 reduces the cost of installation, allows for easily reconfiguration of an existing conveyor system, and provides flexibility for different applications and user needs.

The following is an example of a merging operation. Using a programmed operational method in accordance with the invention, the controller 70 receives a signal from a sensor N indicating that a conveyed article 50 is present in segment N, where “N” indicates any segment in the spiral conveyor 20. A spur section 30 is attached to the spiral conveyor 20 and can also include a sensor S. The controller 70 then checks the condition of a sensor N+1 located in segment N+1 immediately downstream of segment N. The spur section 30 is preferably connected to segment N+1. If the sensor N+1 indicates that segment N+1 is clear, but the sensor S indicates that the spur section 30 is blocked, the controller 70 does not actuate the driving element 34 of the spur section 30 and a conveyed article 50 in segment N moves along the conventional conveying path towards segment N+1. If the sensor N+1 indicates that an article is present in segment N+1, the controller 70 does not actuate a driving element located in segment N or the driving element 34 of the spur section 30, thus accumulating articles in all segments. If the sensor S senses the presence of a conveyed article 50 in the spur section 30 and sensors N and N+1 indicate that segments N and N+1 are both clear, the controller 70 actuates the driving element 34 of the spur section 30 and a conveyed article 50 in the spur section 30 merges onto the segment N of the spiral conveyor 20 and moves along the conveying path towards N+1.

The following is an example of a diverting operation. Using a programmed operational method in accordance with the invention, the controller 70 receives a signal from the sensor N indicating that a conveyed article 50 is present in segment N, where “N” indicates any segment in the spiral conveyor 20. The controller 70 then checks the condition of a sensor N+1 located in segment N+1 immediately downstream of segment N. The spur section 30 is preferably connected to segment N+1. If sensor N+1 indicates that segment N+1 is clear and a conveyed article 50 is designated to be diverted, a divert signal is sent to the controller 70 and a chosen diverting method is actuated to guide the conveyed article 50 towards the spur section 30. Once the conveyed article 50 is ready to be diverted onto the spur section 30, the controller 70 checks for a signal from sensor S. If the sensor S indicates that the spur section 30 is clear, the controller 70 actuates a driving element in segment N and the driving element 34 of the spur section 30 to divert the conveyed article 50 from the segment N of the spiral conveyor onto the spur section 30. If the sensor S indicates that the spur section 30 is blocked, the controller 70 will not actuate the driving elements of segment N and the spur section 30, and the conveyed article 50 will accumulate on the spiral conveyor 20.

Preferably, the spiral conveyor 20 that the spur section 30 is connected to also includes a driving element in the selected segment 28, and means for receiving the divert or merge signal from the sensor 60 and controlling the driving element in accordance with that signal. The driving element in the selected segment 28 can be a reciprocal powered roller, such as the powered roller described in U.S. Pat. No. 5,901,827, that is selectively actuated to rotate alternatively in forward and backward directions. The driving element of the selected segment 28 is preferably arranged adjacent to the entrance to the spur section 30, and positioned with respect to the driving element 34 of the spur section 30 to form an operable conveying path for moving a conveyed article 50 between the selected segment 28 of the spiral conveyor 20 and the spur section 30. For example and without limitation, FIG. 6 shows one potential location where a driving element 29 can be arranged on the selected segment 28. The driving element 29 in the selected segment 28 can be driven by the same driver 38 as the spur section 30, or by a different driver. The controller for the driving element 29 in the selected segment 28 is preferably the controller 70 of the spur section 30, which controls and coordinates the movement of both driving elements as a conveyed article 50 is diverted from or merged onto the spiral conveyor 20. In addition to the driving element 29 located in the selected segment 28, the spiral conveyor 20 can include additional driving elements arranged at various locations on the conveyor segments 22 to control the flow of articles along the conveying path. For example, additional driving elements can be arranged upstream of the spur section 30 and controlled so that as a conveyed article is being diverted or merged, movement of articles upstream of the spur section 30 is slowed or stopped to provide sufficient time for the diverting or merging operation to prevent jamming.

Similarly, the secondary conveyor 40 that the spur section 30 is connected to can also include a driving element 48 and means for receiving a signal from a sensor and controlling the driving element in accordance with that signal. The driving element 48 of the secondary conveyor 40 is preferably arranged adjacent to the exit of the spur section 30, and positioned with respect to the driving and driven elements 34, 36 of the spur section to form an operable conveying path for moving a conveyed article 50 between the spur section 30 and the secondary conveyor 40. The controller for the driving element of the secondary conveyor is also preferably the controller 70 of the spur section 30. In this manner, the driving elements of the spiral conveyor, spur section, and secondary conveyor can all be controlled and coordinated by the same controller 70 as a conveyed article 50 is diverted or merged between the spiral conveyor 20 and the secondary conveyor 40.

When the spiral conveyor is operating in ordinary transport mode, conveyed articles move along the conveyor segments 22 along the conveying path without being diverted or merged, and the driving element 34 of the spur section 30 does not move. When the controller 70 receives a divert signal from a sensor 60, the controller 70 actuates the driving element 34 of the spur section 30 to facilitate the movement of a conveyed article 50 from the spiral conveyor 20 onto the spur section 30. Where a driving element is provided on the selected segment 28 of the spiral conveyor 20 and on the secondary conveyor 40, the controller 70 can actuate each one of those driving elements to guide the conveyed article 50 during the diverting operation. For example, as an article to be diverted enters the selected segment 28 to which the spur section 30 is connected, the controller 70 actuates the driving element on the selected segment 28 in a forward direction towards the spur section 30. A sensor 60 may be used to detect when the article passes the driving element on the selected segment 28, so the controller 70 can turn that driving element off and actuate the driving element 34 on the spur section 30 in a forward direction towards the secondary conveyor 40. As the article passes through the spur section 30, another sensor 60 can be used to detect the movement of the article so that the controller 70 can turn the driving element 34 on the spur section 30 off and actuate the driving element on the secondary conveyor 40 in a forward direction until the article reaches a desired location on the secondary conveyor 40. When the controller 70 receives a merge signal from a sensor 60, the above operation is repeated in reverse, with the driving elements of the secondary conveyor 40, the spur section 30, and the selected segment 28 of the spiral conveyor 20 being actuated sequentially in a reverse direction to merge the article from the secondary conveyor 40 back onto the spiral conveyor 20. After a sensor arranged on the spiral conveyor 20 detects that the article has been reintroduced onto the selected segment 28, the driving element of the selected segment 28 can be actuated in a forward direction to guide the article along the conveying path towards the exit segment 27. As discussed above, the controller 70 can also actuate the movement of additional driving elements arranged upstream and downstream of the spur section 30 to control the flow of articles as a conveyed article 50 is being diverted or merged to avoid jamming. Where multiple spur sections 30 and multiple secondary conveyors 40 are connected to the spiral conveyor 20, multiple controllers 70 or a single controller 70 can be used to simultaneously actuate and coordinate the movement of the driving elements for individual merging or diverting operations at each spur section 30.

A divert signal will usually be initiated by a blocked condition downstream of the spur section 30, such as at the exit segment 27. When this occurs, the controller 70 can first actuate driving elements downstream of the spur section 30 on the spiral conveyor 20 in a reverse direction to accumulate articles and prevent further build up. The controller 70 can then divert articles upstream of the spur section 30 from the spiral conveyor 20 through the spur section 30 onto a secondary conveyor 40, as described above. Once the blocked condition has been resolved and a sensor 60 generates a merge signal, the controller 70 can then reintroduce articles from the secondary conveyor 40 back onto the spiral conveyor 20, as described above. A sensor 60 may also generate a divert signal if it detects the presence of an article that is designated to be diverted. The diverting signal can be based on a barcode read from a conveyed article 50, or based on a load balancing at the location of the sensor 60. Once the sensor 60 no longer detects the presence of an article for a predetermined time duration, the sensor may generate a merge signal so that diverted articles can be reintroduced onto the spiral conveyor 20. The time duration for the merge signal should be sufficiently long to avoid merging articles back on the spiral conveyor 20 for simple shifts or slippage of the blocked articles. The predetermined time durations can be adjusted based on the operating conditions of the conveyor system, such as the size and normal transport speed of the conveyed articles.

The diverting and merging operations can also be initiated and coordinated for vertical sortation of the conveyed articles on the spiral conveyor 20. As the sensors 60 arranged on the conveyor segments 22 detect the presence of conveyed articles, each sensor 60 may selectively generate a diverting signal based on the number of passing articles, or other characteristics, so that the articles on the spiral conveyor 20 can be vertically sorted onto secondary conveyors 40 arranged at different levels between the feed conveyor 42 and the takeaway conveyor 44. The vertically sorted articles can travel along the secondary conveyors 40 to different locations, or they can be sequentially unloaded from the exit segment 27 of the spiral conveyor 20 through separate merging operations for each secondary conveyor 40.

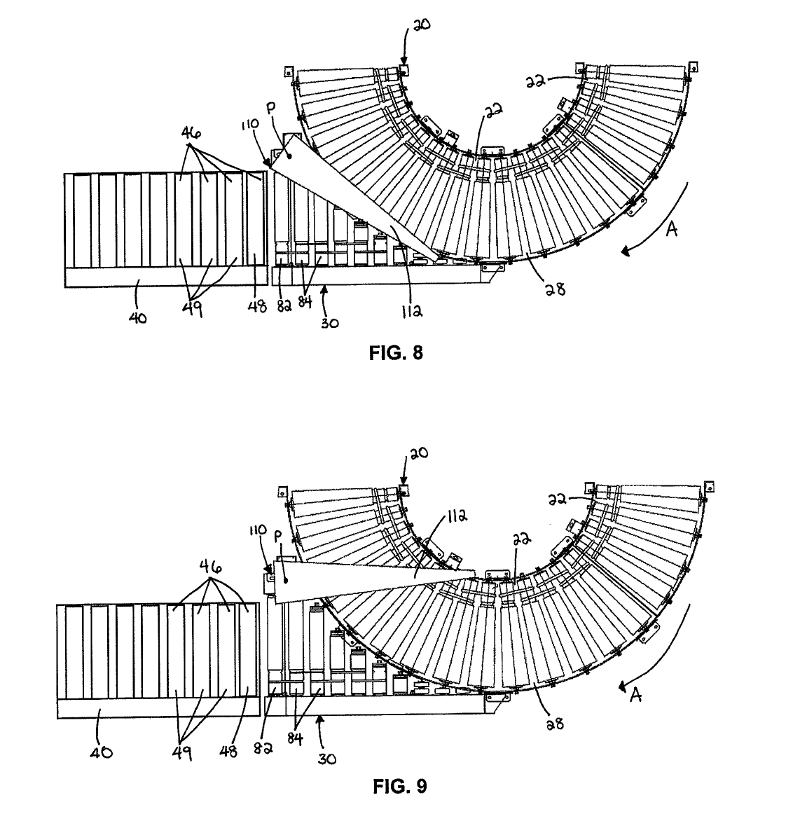

To aid the movement of a conveyed article 50 as it is being diverted from or merged onto the spiral conveyor 20, an optional guide mechanism may be provided on the selected segment 28 of the spiral conveyor 20 or on the spur section 30. The guide mechanism may have any configuration suitable for the particular conveyor system and the type of articles being conveyed, and is preferably controlled by the controller 70 of the spur section. FIGS. 3-7 show one potential embodiment of a guide mechanism 100 arranged on the spur section 30. The guide mechanism 100 includes a sliding element 102 that moves along the length of the spur section 30 between a retracted position (as shown in FIG. 6) and an extended position (as shown in FIG. 7). The sliding element 102 can include an actuator controlled by the controller 70 of the spur section 30, or by a separate controller. As shown in FIG. 6, during normal operation of the spiral conveyor 20 where conveyed articles move in a direction A along the conveyor segments 22, the guide mechanism 100 is maintained in the retracted position so that conveyed articles are free to move past the spur section 30 along the spiral conveyor 20. When the controller 70 or the separate controller of the guide mechanism 100 receives a divert or merge signal from a sensor 60, the sliding element 102 extends into and blocks a section of the selected segment 28 of the spiral conveyor 20. When the guide mechanism 100 is extended, as shown in FIG. 7, a conveyed article 50 is guided from the spiral conveyor 20 onto the spur section 30, or vice versa. Once the diverting or merging operation is complete, the sliding element 102 is moved to the retracted position so that conveyed articles can continue to move along the spiral conveyor 20.

FIGS. 8 and 9 show an alternate embodiment of a guide mechanism 110 arranged on the spur section 30 that includes a pivoting arm 112 that pivots about a point P. As discussed above with respect to the guide mechanism 110 shown in FIGS. 3-7, the guide mechanism 110 can be controlled by the controller 70 of the spur section 30, or by a separate controller. As shown in FIG. 8, the pivoting arm 112 blocks the entrance of the spur section 30 during normal operation of the spiral conveyor 20 to avoid an unintentional diversion or merge. When the controller 70 or the separate controller of the guide mechanism 110 receives a divert or merge signal from a sensor, the pivoting arm 112 moves to open the entrance of the spur section 30 and to block a section of the selected segment 28 of the spiral conveyor 20 so that a conveyed article 50 is guided from the spiral conveyor 20 onto the spur section, or vice versa. Once the diverting or merging operation is complete, the pivoting arm 112 is moved back to block the entrance of the spur section 30. Although the pivoting arm 112 shown in FIGS. 8 and 9 is formed as a straight element, it can alternatively be curved to match the curvature of the conveyor segments 22 of the spiral conveyor 20. One of ordinary skill in the art would appreciate that other guide mechanisms can be used to help move a conveyed article 50 between the spiral conveyor 20 and the spur section 30. For example and without limitation, a pop-up device may be installed on the spiral conveyor 20 itself, with a movable element that protrudes and retracts from the gap between two adjacent rollers to block and unblock a section of the spiral conveyor 20, so that a conveyed article 50 is guided onto the spur section. A similar pop-up device may be installed on the spur section 30, with a movable element that protrudes and retracts from the gap between two adjacent rollers on the spur section 30 to block and unblock the entrance to the spur section 30.

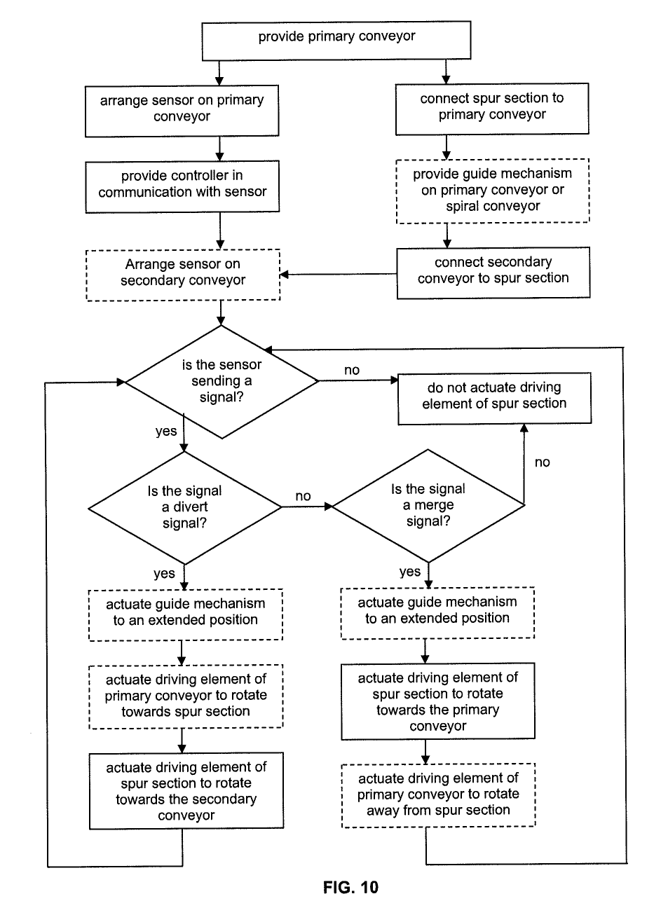

FIG. 10 is a flow diagram showing a method for diverting and merging a conveyed article 50 between a primary conveyor and a secondary conveyor 40. The method includes the step of providing a primary conveyor, such as the spiral conveyor 20 described above, and connecting a spur section 30 to the primary conveyor. The spur section 30 includes a driving element, which can be a reciprocating driving element that can rotate in opposing directions. Optionally, a guide mechanism is provided on the primary conveyor or the spur section 30. The method further includes the steps of connecting a secondary conveyor 40 to the spur section 30, arranging a sensor 60 on the primary conveyor 20 at a predetermined distance from the conveyor that detects a conveyed article 50 and selectively generates a divert signal or a merge signal. A further sensor 60 may optionally be arranged on the secondary conveyor 40. A controller 70 is provided to receive the divert signal or merge signal from the sensor 60 and control the driving element of the spur section 30 in accordance with that signal. If the controller 70 does not receive any signals from the sensor 60, the driving element of the spur section 30 is not actuated and articles are free to move along the primary conveyor. When the controller 70 receives a divert signal, the guide mechanism may optionally be actuated to an extended position to guide a conveyed article 50 from the primary conveyor onto the spur section 30, and the driving element of the spur section 30 is actuated to rotate towards the secondary conveyor 40. In this manner, a conveyed article 50 can be diverted from the primary conveyor to the secondary conveyor 40. Similarly, when the controller 70 receives a merge signal, the guide mechanism may optionally be actuated to an extended position so that a conveyed article 50 is free to move from the spur section 30 onto the primary conveyor. The driving element of the spur section is actuated to rotate towards the primary conveyor, so that a conveyed article 50 can be merged from the secondary conveyor 40 to the primary conveyor.

The primary conveyor that the spur section 30 is connected to may optionally include a driving element that cooperates with the driving element of the spur section 30 to divert a conveyed article 50 from the primary conveyor or merge a conveyed article 50 onto the primary conveyor. When the conveyed article 50 is being diverted from the primary conveyor, the driving elements of the primary conveyor and the spur section 30 can be rotated, either simultaneously or sequentially, towards the secondary conveyor 40. When the conveyed article 50 is being merged onto the primary conveyor, the driving elements of the primary conveyor and the spur section 30 can be rotated, either simultaneously or sequentially, away from the secondary conveyor 40. As shown in FIG. 10, when the controller 70 receives a divert signal, the driving element of the primary conveyor may optionally be actuated to rotate towards the spur section 30 to aid in diverting a conveyed articled 50 from the primary conveyor onto the spur section 30. When the controller 70 receives a merge signal, the driving element of the primary conveyor may optionally be actuated to rotate away from the spur section 30 to aid in merging a conveyed article from the spur section 30 onto the primary conveyor.

Various methods, configurations, and features of the present invention have been described above and shown in the drawings, one of ordinary skill in the art will appreciate from this disclosure that any combination of the above features can be used without departing from the scope of the present invention. It is also recognized by those skilled in the art that changes may be made to the above described methods and embodiments without departing from the broad inventive concept thereof.

What is claimed is:

1. A spur section for connecting a primary conveyor to a secondary conveyor, comprising:
a frame configured for attachment to a selected segment of a primary conveyor;
a driving element associated with the frame;
a driven element associated with the frame;
a driver that powers the driving element;
a sensor arranged on the selected segment of the primary conveyor that detects a conveyed article and selectively generates a divert signal or a merge signal; and
a controller that receives the divert signal or the merge signal from the sensor and controls the driving element in accordance with the divert signal or the merge signal.

2. The spur section of claim 1, wherein when the controller receives the divert signal from the sensor, the driving element is actuated to divert a conveyed article from the primary conveyor to the secondary conveyor.

3. The spur section of claim 1, wherein when the controller receives the merge signal from the sensor, the driving element is actuated to merge a conveyed article from the secondary conveyor to the primary conveyor.

4. The spur section of claim 1, wherein the primary conveyor is a spiral conveyor having a plurality of conveyor segments supported by a conveyor frame and arranged as a spiral, including an entry segment at a first level and an exit segment at a second level, the selected segment being arranged between the entry segment and the exit segment, and means for receiving the divert signal or the merge signal from the sensor and controlling a driving element arranged on the selected segment.

5. The spur section of claim 1, wherein the driving element comprises a powered roller and the driven element comprises a non-powered roller motivated by the powered roller.

6. The spur section of claim 1, wherein the driving element and the driven element are arranged substantially parallel to an adjacent roller arranged on the secondary conveyor.

7. The spur section of claim 1, wherein the driving element comprises a powered roller and the driven element comprises a belt arranged around the powered roller.

8. The spur section of claim 7, wherein the belt is arranged substantially perpendicular to the powered roller.

9. The spur section of claim 1, further comprising a guide mechanism having a movable element that guides a conveyed article between the primary conveyor and the spur section.

10. The spur section of claim 1, wherein the frame has a substantially triangular shape.

11. A spiral conveyor having a spur section, comprising:
a plurality of conveyor segments supported by a conveyor frame and arranged as a spiral, including an entry segment at a first level and an exit segment at a second level, the spur section attached to one of the plurality of conveyor segments at an intermediary level between the first and second levels;
a sensor that detects a conveyed article on a selected conveyor segment and selectively generates a divert signal or a merge signal;
a first powered roller mounted on the selected conveyor segment;
a second powered roller mounted on the spur section; and
a controller that receives the divert signal or the merge signal and controls the first and second powered rollers in accordance with that signal to divert a conveyed article from the selected conveyor segment to the spur section or merge a conveyed article from the spur section to the selected conveyor segment.

12. The spiral conveyor of claim 11, wherein the spur section has a frame with opposing first and second ends, the first end being configured for attachment to the one of the plurality of conveyor segments and the second end being configured for attachment to a secondary conveyor.

13. The spiral conveyor of claim 11, wherein a plurality of spur sections are connected to the plurality of conveyor segments at positions between the entry segment and the exit segment.

14. The spiral conveyor of claim 11, further comprising an additional sensor arranged downstream of the selected conveyor segment that detects a conveyed article and generates an additional signal, wherein the controller receives the additional signal and controls the first and second powered rollers in accordance with the additional signal.

15. The spiral conveyor of claim 11, wherein the first and second powered rollers are positioned with respect to each other to form an operable conveying path for moving a conveyed article between the selected conveyor segment and the spur section.

16. A method for diverting and merging a conveyed article between a primary conveyor and a secondary conveyor, the method comprising the steps of:
providing a primary conveyor;
connecting a spur section to the primary conveyor, the spur section having a driving element;
connecting a secondary conveyor to the spur section;
arranging a sensor on the primary conveyor at a predetermined distance from the spur section, the sensor being configured to detect a condition of a conveyed article and selectively generate a divert signal or a merge signal in response to the detected condition; and
providing a controller that receives the divert signal or the merge signal and controls the driving element of the spur section in accordance with that signal to rotate towards the secondary conveyor to divert a conveyed article away from the primary conveyor, or rotate towards the primary conveyor to merge a conveyed article onto the primary conveyor.

17. The method of claim 16, wherein the primary conveyor includes a driving element that is controlled by the controller and cooperates with the driving element of the spur section to divert a conveyed article away from the primary conveyor or merge a conveyed article onto the primary conveyor.

18. The method of claim 16, further comprising the step of arranging an additional sensor on the secondary conveyor that detects a condition of a conveyed article and generates an additional signal, wherein the controller receives the additional signal and controls the driving element of the spur section in accordance with the additional signal.

19. The method of claim 16, wherein when the controller receives the divert signal, the driving element of the spur section is controlled to rotate towards the secondary conveyor, and when the controller receives the merge signal, the driving element of the spur section is controlled to rotate towards the primary conveyor.

20. The method of claim 16, further comprising the step of providing a guide mechanism arranged on the primary conveyor or the spur section, the guide mechanism having a movable element that is selectively actuated to guide a conveyed article between the primary conveyor and the spur section.
